(19) United States
(12) Patent Application Publication
(10) Pub. No.: US 2003/0111751 A1
(43) Pub. Date: Jun. 19, 2003

(54) Process for converting a device for the production of acrylic resin dental prostheses to use acetal and similar resins

(75) Inventors: Giorgio Monticelli, Cattolica RN (IT); Stefano Monticelli, Cattolica RN (IT)

Correspondence Address: COHEN, PONTANI, LIEBERMAN & PAVANE, 551 FIFTH AVENUE, SUITE 1210, NEW YORK, NY, 10176, US

(73) Assignee: Pressing Dental S.r.I.

(21) Appl. No.: 10/291,991

(22) Filed: Nov. 12, 2002

(30) Foreign Application Priority Data
Nov. 9, 2001 (IT) PS 2001 A 00026

(51) Int. Cl. B29C 45/00

(52) U.S. Cl. 264/16; 264/39; 425/542

(57) ABSTRACT

A prior art dental prosthesis molding device designed for use with acrylic resin is converted for use with acetal resin by providing a pressing device specially configured to deliver resin injection pressure that substantially exceeds that needed for acrylic, polyvinyl and similar resins. The resin cartridge and cartridge holder of the prior art are replaced with new components fabricated of metal. Substitution of a screw cursor for a pawl retention mechanism strengthens the mold-muffle against expansion and distortion under the elevated pressure of the injected resin.

### BACKGROUND OF THE INVENTION

1. Priority

This application claims priority from patent application No. PS 2001 A 000026, filed in Italy on Nov. 9, 2001.

2. Field of the Invention

The present invention relates to production of dental prostheses. More specifically, the present invention relates to the use of acetal, and other resins requiring similar injection pressure, to mold dental prostheses.

3. Description of the Related Art

Complete manufacturing devices and kits exist for using acrylic, polyvinyl or similar resins to make total and partial dental prostheses or dental replacement parts such as tooth replacements.

A conventional Ivoclar system 10, for example, which produces dental prostheses in acrylic, polyvinyl and similar resins, splits the resin into components, e.g., a polymer and a monomer, that are then provided in separate pre-dosed cartridges. To create a dental prosthesis, and referring to FIG. 1, the components are mixed using a special vibrator and injected, from a Teflon cartridge 15, into a mold-muffle 11 having two mating valves 13 that mate to form a generally rectangular enclosure. A hollow, cartridge-holder cylindrical union-push rod 14, also made of Teflon, resides radially between the two mating valves 13. One end of the rod 14 leads into the mold-muffle, and the other end receives an inserted cartridge 15. The cartridge receiving end features an external circumferential surround (not shown) to which an upper pneumatic pressing device (not shown) is retained by means of clamps (not shown). The cartridge 15 is inserted into the rod 14, and the piston of the pneumatic pressing device penetrates the cartridge 15 to inject the mixed resin from the cartridge 15, into the rod 14, and through to the mold-muffle 11. Injection pressure is maintained to compensate for any retraction or shrinkage of the resin that may occur as a result of polymerization. A special container 12 encloses the mold-muffle, and a pawl retention mechanism (not shown) disposed between the mold-muffle 11 and the container 12 presses the mold-muffle 11 against the container 12 to keep both valves 13 of the mold-muffle 11 together in opposition to the force exerted by the injected resin under the urgency of the injection pressure.

Acetal resins, which have only recently been utilized in dental and orthodontic technology in the making of prostheses and appliances, have physical and mechanical characteristics that allow the production of a far wider range of these devices in comparison to that available through the use of acrylic, polyvinyl and similar resins. For example, acetal resins can be used to form articles that previously could only be fabricated of metal. Among non-reinforced plastic materials, acetal homopolymer is one of the most rigid and strongest: its hardness is from six to twenty times higher than that of acrylic resins that have traditionally been used in the industry. At the same time, acetal polymer is able to maintain an elastic memory suitable for substantially any dental prosthetic appliance and is without any contraindications in terms of immunology, hygiene and discomfort to the user.

Known mold-muffle devices, however, are unsuitable for fashioning dental prostheses in acetal resin, which must first be melted and then injected into a mold-muffle at much higher injection pressures than those required for normal acrylic, polyvinyl and similar resins. A conventional mold-muffle is undersized and not equipped for withstanding the resulting applied forces, and cannot effectively mold dental prostheses from acetal resins utilizing the substantially lesser pressures employed in the molding of acrylic devices. Accordingly, there exists a need for a method and apparatus by which dental prostheses can be produced safely, conveniently and effectively using acetal resins and other polymer resins that require high injection temperatures, such as nylon.

### SUMMARY OF THE INVENTION

The present invention is directed to the fabrication and shaping of dental prostheses in acetal resin using existing equipment that is widely used for the production of prostheses from acrylic, polyvinyl and similar resins. By converting existing devices for use in the innovative process of the present invention, the user is relieved of the inconvenience and cost of acquiring new or additional equipment. In short, the conversion entails providing an increased-pressure source for injecting acetal resin at the required higher pressures, replacing the cartridge and cartridge-holder rod of the prior art with ones made of metal, and fortifying the mold-muffle to withstand the increased injection pressure required by the resin.

An object of the invention is therefore to provide a conversion process that is reversible to permit the re-use of the device with the polymer resins for which the device was originally designed.

A further object of the invention is to enable the fabrication of prostheses in other polymer resins that require a high injection pressure, such as nylon.

A still further object of the invention is to provide a quick method of conversion of heretofore-available apparatus to meet production immediacy.

Another object of the invention is to provide a conversion method that does not subvert the original structures of the fabrication apparatus that is converted for use in practicing the invention.

Yet another object of the invention is to provide a simple and inexpensive conversion process.

A still further object of the invention is to provide a conversion method that achieves a high degree of modularity.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference numbers denote similar elements throughout the several views:

FIG. 1 is an elevated perspective view of a prior art dental prosthesis molding device.

FIG. 2 is an elevated perspective view of a first embodiment of a dental prosthesis molding device in accordance with the present invention; and

FIG. 3 is an elevated perspective view of a second embodiment of a dental prosthesis molding device in accordance with the present invention.

### DETAILED DESCRIPTION OF THE PRESENTLY PREFERRED EMBODIMENTS

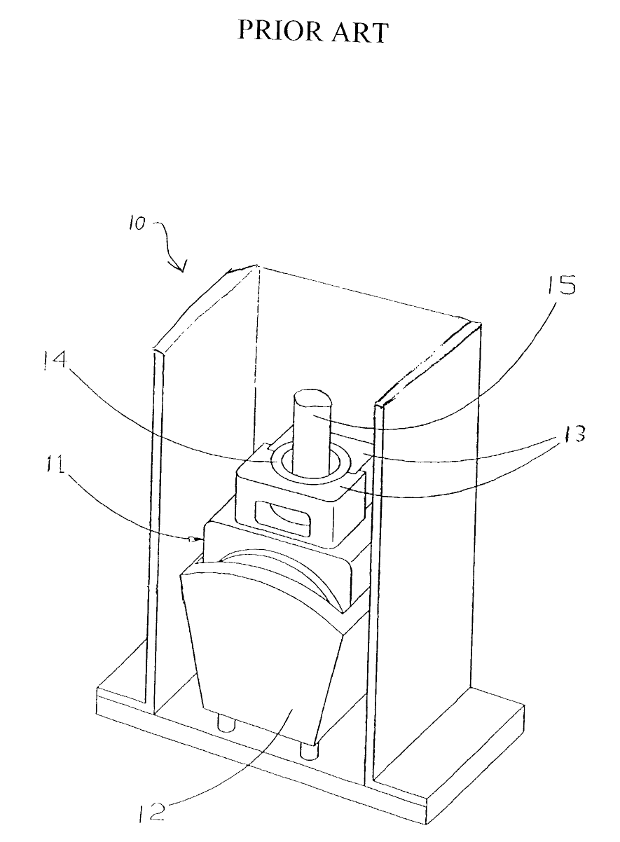

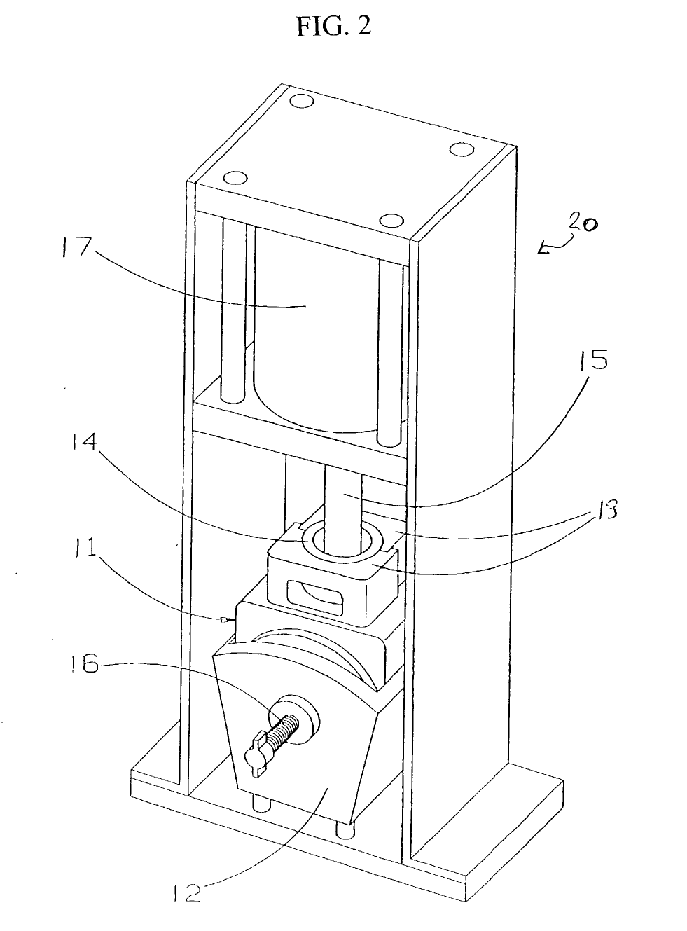

FIG. 2 depicts, by way of illustrative and non-limiting example, a first embodiment of a dental prosthesis molding device 20 for production of prostheses in acetal and other resins requiring relatively high injection pressure in accordance with the invention. Device 20 has been converted from a conventional molding device such as that shown in FIG. 1, in which the same reference numbers have been retained to identify identical components or structures. As shown in FIG. 2, an increased-power pressing device implemented as a pneumatic pressing device 17 is disposed above the mold-muffle 11. The device 17 has a piston (not shown) in axial alignment with a cylindrical resin applicator or cartridge 15. The increased-power or “increased-pressure” pneumatic pressing device 17 must be of a type that can provide sufficient pressure to inject resins such as acetal resin, nylon and other resins that require substantially higher injection pressure than that required to inject acrylic and like resins. One example of a suitable pressing device 17 is the Pressing type model “J-M”, made by Pressing Dental S.r.I. of San Marino.

Converted device 20 also includes a counter pressure device or screw cursor 16 in place of the pawl retention mechanism of the prior art device, i.e. of the original device before conversion. As shown, the screw cursor is configured to contact sufficient surface areas of the mold-muffle 11 and the container 12 so that in pressing between the mold-muffle 11 and container 12, the screw cursor 16 effectively opposes expansion of the mold-muffle 11.

Importantly, the resin cartridge 15 and the cartridge-holder cylindrical union-push rod 14 are both formed of metal so as to withstand the increased pressure. The cartridge 15 may be of the collapsible or non-collapsible type.

To operate the converted device 20 to mold prostheses in acetal and similar resins, the metal resin cartridge 15 is first filled with resin, which is normally supplied in a granular or shredded state. The resin in the cartridge 15 is melted, for example, by placing the cartridge in an electric oven such as the Pressing type model “H2”, manufactured by Pressing Dental S.r.I.

When the resin reaches a desired melted-fluid state at an effective temperature for molding in accordance with known parameters, the cartridge 15 can be fitted by axial insertion into the cartridge-holder rod 14 and penetrated by the piston of the pneumatic pressing device 17. The piston of device 17 performs a compressing action of the resin, thereby forcing the resin through the extrusion mouth within the mold-muffle 11. Advantageously, the screw cursor 16 prevents the valves 13 from distorting under the relatively high pressure required to inject acetal resin in forming the prosthesis.

At the conclusion of this extrusion stroke, the injection pressure is maintained to keep the resin sliding on itself but at a reduced flow rate. As a result, the resin is caused to completely fill any vacant space that may arise in mold-muffle 11 through retraction of the resin under the effects of polymerization and cooling.

In a variation of the first embodiment of FIG. 2, in converting the original apparatus a compressed-air adductor of the upper pneumatic pressing device can be replaced with, or adjusted to function as, an increased-pressure compressed-air-adductor, with the upper pneumatic pressing device otherwise retained.

In a further variation, the original adductor and the increased-pressure adductor can be configured for ready interchangeability so that one can be selectively removed and replaced by the other. In that case the original adductor can be used for acrylic and other lesser injection pressure resins, and the increased-pressure adductor employed for acetal and other resins requiring substantially higher injection pressure.

Preferably, in either variation reduced-diameter cartridges 15 will be utilized to reduce the injection force, and a correspondingly reduced-diameter injector piston head will be employed. The outer diameter of the cylindrical piston head and the diameter of the interior of the cartridge 15 are accordingly configured so that the head fits into the cartridge.

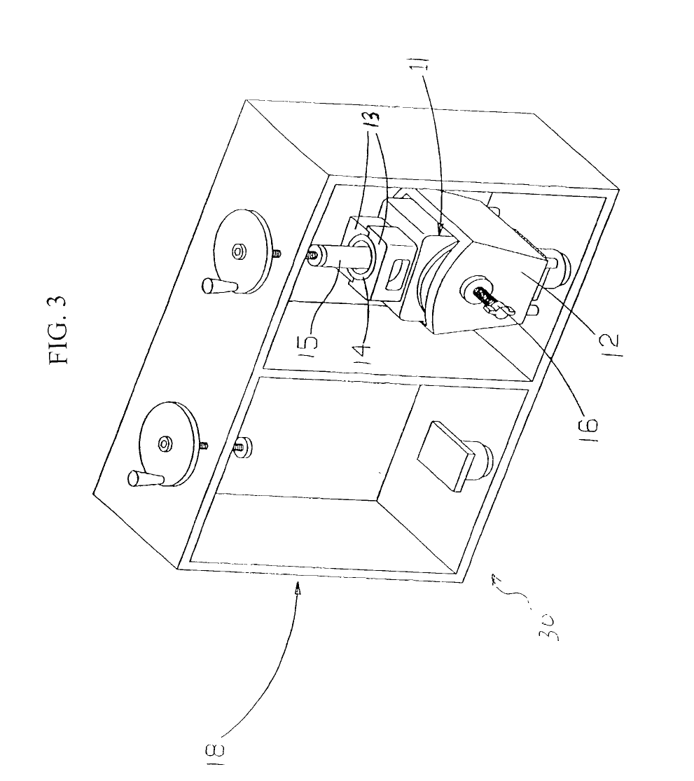

A second exemplary embodiment, shown in FIG. 3, employs a crank-driven threaded axle in a device 18 to maintain pressure on the resin. The muffle 11, container 12 and cartridge 15 used in the first embodiment of FIG. 2 may for example be employed in device 18 of the second embodiment to free the pneumatic pressing device 17 for other tasks.

While there have been shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for converting a pre-existing device for the production of dental prostheses using a first polymer resin into a converted device, the pre-existing device having a mold-muffle with mating valves that mate to form a generally rectangular enclosure, the preexisting device further having a hollow, cylindrical, non-metal rod disposed radially between the mating valves, one end of the cylindrical rod being connected to the mold-muffle and an opposite end of the rod being disposed for contact with a non-metal resin applicator so that the first polymer resin is injectable through the cylindrical rod and into the mold-muffle, the converted device being configured for production of dental prostheses using a second polymer resin that requires substantially higher injection pressure than does the first polymer resin, said method comprising the steps of:
replacing the non-metal cylindrical rod with a cylindrical rod made of metal;
replacing the non-metal resin applicator with a resin applicator made of metal; and
providing an increased-pressure pressing device configured for injecting, with said substantially higher injection pressure, the second resin from the metal resin applicator through the metal cylindrical rod and into the mold-muffle to thereby shape a dental prosthesis within the mold-muffle.

2. The method of claim 1, further comprising the steps of:
providing a container to surround the mold-muffle; and
providing a counter-pressure device that contacts sufficient surface areas of the mold-muffle and the container so that, in pressing between the mold-muffle and the container, the counter-pressure device effectively opposes expansion of the mold-muffle under pressure exerted by said second resin injected by the increased-pressure pressing device.

3. The method of claim 2, wherein said counter pressure device comprises a screw cursor that passes through the container to contact the mold-muffle.

4. The method of claim 1, wherein the metal resin applicator comprises a metal cartridge that is one of collapsible and non-collapsible.

5. The method of claim 1, wherein the metal of the metal resin applicator comprises steel.

6. The method of claim 1, further comprising the step of heating the resin in the metal resin applicator with an electric oven.

7. The method of claim 1, wherein the increased-pressure pressing device comprises a pneumatic pressing device.

8. The method of claim 1, wherein the increased-pressure pressing device comprises a crank-driven threaded axle.

9. The method of claim 1, further comprising the step of operatively using the converted device to form the dental prosthesis from acetal resin.

10. The method of claim 1, further comprising the step of operatively using the converted device to form the dental prosthesis from nylon.

11. The method of claim 1, wherein the first polymer resin comprises acrylic resin.

12. The method of claim 11, wherein the second polymer resin comprises acetal resin.

13. The method of claim 1, wherein the pre-existing device further includes a pre-existing pressing device for injecting the first polymer resin through the non-metal cylindrical rod and into the mold-muffle, the pre-existing pressing device comprising a pre-existing compressed-air adductor, said providing step further comprising the step of replacing the pre-existing compressed-air adductor with an increased-pressure compressed-air adductor configured to deliver the substantially higher injection pressure.

14. The method of claim 13, wherein the metal and non-metal resin applicators are both cylindrical and have respective interiors with respective interior diameters, said increased-pressure compressed-air adductor having an injector piston for injecting resin, and the piston having a cylindrical head with an outside diameter, and wherein the outside diameter of the cylindrical head and the interior diameter of the metal resin applicator are sized smaller than the interior diameter of the non-metal resin applicator and so that the piston fits into the interior of the metal resin applicator.

15. The method of claim 13, wherein the pre-existing and increased-pressure compressed-air adductors are configured for selected removal and replacement, one by the other, for respective molding of prostheses using the first polymer resin and the second polymer resin.

16. The method of claim 15, wherein the metal and non-metal resin applicators are both cylindrical and have respective interiors with respective interior diameters, said increased-pressure compressed-air adductor having an injector piston for injecting resin, and the piston having a cylindrical head with an outside diameter, and wherein the outside diameter of the cylindrical head and the interior diameter of the metal resin applicator are sized smaller than the interior diameter of the non-metal resin applicator and so that the piston fits into the interior of the metal resin applicator.

17. The method of claim 1, further including the steps of:
heating to fluidization the second polymer resin in the metal resin applicator;
injecting the fluidized second polymer resin from the metal resin applicator into the mold-muffle; and
maintaining injection pressure during cooling of the second polymer resin in the mold-muffle to compensate for retraction of the cooling second polymer resin.

18. The method of claim 1, wherein the pre-existing device further comprises a container to surround the mold-muffle, said method further comprising the step of:
providing a counter-pressure device that contacts sufficient surface areas of the mold-muffle and of the container so that, in pressing between the mold-muffle and the container, the counter-pressure device effectively opposes expansion of the mold-muffle under pressure exerted by said second resin injected by the increased-pressure pressing device.

19. Apparatus for forming a dental prosthesis, said apparatus comprising:
a hollow, cylindrical resin applicator;
an increased-pressure pressing device configured for insertion into the resin applicator;
a mold-muffle having mating valves and a hollow, metal cylindrical rod disposed radially between the valves, one end of the metal cylindrical rod being connected to the mold-muffle and another end of the rod being disposed for operative injection, by the increased-pressure pressing device inserted into the resin applicator, of heated resin from the resin applicator into the mold-muffle through the cylindrical rod;
a container surrounding the mold-muffle; and
a counter-pressure device that contacts sufficient surface areas of the mold-muffle and the container so that, in pressing between the mold-muffle and the container, the counter-pressure device effectively opposes expansion of the mold-muffle under pressure exerted by the resin injected by the increased-pressure pressing device.

20. The apparatus of claim 19, wherein said counter-pressure device comprises a screw cursor that passes through the container to contact the mold-muffle.
